(19) United States
(12) Patent Application Publication
(10) Pub. No.: US 2015/0227177 A1
(43) Pub. Date: Aug. 13, 2015

(54) TABLET COMPUTER AND METHOD FOR COUPLING A COMPUTER CABLE TO THE TABLET COMPUTER

(71) Applicant: AMES ADT, Inc., Traverse City, MI (US)

(72) Inventor: Daniel Rengier McKean, Traverse City, MI (US)

(21) Appl. No.: 14/618,494

(22) Filed: Feb. 10, 2015

Related U.S. Application Data
(60) Provisional application No. 61/939,184, filed on Feb. 12, 2014.

(51) Int. Cl. G06F 1/18; G06F 1/16

(52) U.S. Cl. CPC G06F 1/181; G06F 1/1637; G06F 1/1684; G06F 1/1626

(57) ABSTRACT

A tablet computer includes a front display assembly and a rear housing that receives the front display assembly on a first side thereof. The tablet computer further includes a controller assembly that is coupled to a second side of the rear housing. The controller assembly has a controller housing and PCB assembly disposed in the controller housing. The PCB assembly has a microprocessor, a PCB, and a first I/O port connector. The controller housing has a first side wall with an aperture extending therethrough that is disposed adjacent to the first I/O port connector. The tablet computer further includes a first panel that is removably coupled to a portion of the second side of the rear housing such that the first panel and the first side wall define a first elongated aperture therebetween.

### CROSS-REFERENCE TO RELATED APPLICATIONS

This application claims priority to U.S. Provisional Patent Application No. 61/939,184 filed on Feb. 12, 2014, the entire contents of which are hereby incorporated by reference herein.

### BACKGROUND

The inventor herein has recognized a need for an improved tablet computer that provides at least one panel on a rear housing that is removable to allow computer cables to be operably coupled to I/O port connectors of the tablet computer. Further, the panel is reattachable to the rear housing to securely protect the I/O port connectors of the tablet computer and electrical connectors of the computer cables.

### SUMMARY

A tablet computer in accordance with an exemplary embodiment is provided. The tablet computer includes a front display assembly. The tablet computer further includes a rear housing defining an interior region that receives the front display assembly therein. The front display assembly is coupled to a first side of the rear housing. The tablet computer further includes a controller assembly that is coupled to a second side of the rear housing. The controller assembly has a PCB (i.e., printed circuit board) assembly and a controller housing. The PCB assembly is disposed in the controller housing. The PCB assembly has a microprocessor, a PCB (i.e., printed circuit board), and at least a first I/O port connector. The microprocessor and the first I/O port connector are disposed on the PCB. The first I/O port connector is further operably coupled to the microprocessor. The controller housing has a first side wall extending outwardly from the second side. The first side wall has a first aperture extending therethrough. The first I/O port connector is disposed adjacent to the first aperture such that the first I/O port connector communicates with the first aperture. The tablet computer further includes a first panel that is removably coupled to the second side of the rear housing and adjacent to the first side wall of the controller housing such that the first panel and the first side wall define a first elongated aperture therebetween that is disposed proximate to the first I/O port connector.

A method for coupling a computer cable to a tablet computer in accordance with another exemplary embodiment is provided. The method includes providing the tablet computer having a front display assembly, a rear housing, a controller assembly, and a first panel. The front display assembly is coupled to a first side of the rear housing. The controller assembly is coupled to a second side of the rear housing. The controller assembly has a controller housing and a PCB assembly disposed in the controller housing. The PCB assembly has a PCB and a microprocessor and at least a first I/O port connector disposed on the PCB. The controller housing has a first side wall with a first aperture extending therethrough. The first I/O port connector is disposed adjacent to the first aperture. The method includes providing a first computer cable having a first cable portion and a first connector. The method further includes removing the first panel from the second side of the rear housing such that the first I/O port connector is accessible. The method further includes coupling the first connector of the first computer cable to the first I/O port connector. The method further includes coupling the first panel to the second side of the rear housing such that the first cable portion extends through a first elongated aperture defined between the first panel and the first side wall of the controller housing, and first connector is entirely disposed in a first interior space defined by the second side of the rear housing, the first panel, and the first side wall of the controller housing.

### BRIEF DESCRIPTION OF THE DRAWINGS

FIG. 1 is a schematic of a tablet computer in accordance with an exemplary embodiment;

FIG. 2 is another schematic of a portion of the tablet computer of FIG. 1

FIG. 3 is a schematic of a rear side of the tablet computer of FIG. 1;

FIG. 4 is another schematic of the rear side of the tablet computer of FIG. 1 with first and second panels removed;

FIG. 5 is a first end view of the tablet computer of FIG. 1;

FIG. 6 is a second end view of the tablet computer of FIG. 1;

FIG. 7 is another schematic of the rear side of the tablet computer of FIG. 1 with a first panel removed therefrom such that a first set of I/O port connectors are accessible, and first and second cables coupled to first and second I/O port connectors;

FIG. 8 is another schematic of the rear side of the tablet computer of FIG. 1 with a second panel removed therefrom such that a second set of I/O port connectors are accessible;

FIG. 9 is another schematic of the rear side of the tablet computer of FIG. 1 with the first panel removed therefrom such that the first set of I/O port connectors are accessible, and first and second cables coupled to first and second I/O port connectors;

FIG. 10 is an exploded view of the tablet computer of FIG. 1;

FIG. 11 is a partially exploded view of the tablet computer of FIG. 1;

FIG. 12 is another partially exploded view of the tablet computer of FIG. 1;

FIG. 13 is an exploded view of a front display assembly utilized in the tablet computer of FIG. 1;

FIG. 14 is a schematic of a display chassis utilized in the front display assembly of FIG. 13;

FIG. 15 is a schematic of a PCB assembly utilized in the front display assembly of FIG. 13;

FIG. 16 is a schematic of a first side of a rear housing utilized in the tablet computer of FIG. 1;

FIG. 17 is another schematic of the first side of the rear housing of FIG. 16;

FIG. 18 is a schematic of a second side of the rear housing of FIG. 16;

FIG. 19 is another schematic of the second side of the rear housing of FIG. 16;

FIG. 20 is an exploded view of a controller assembly utilized in the tablet computer of FIG. 1;

FIG. 21 is a schematic of a housing portion utilized in the controller assembly of FIG. 20;

FIG. 22 is a partially transparent schematic of a rear side of the housing portion of FIG. 21 illustrating some of the opposing inner walls and apertures thereof;

FIG. 23 is a schematic of a PCB assembly utilized in the controller assembly of FIG. 20;

FIG. 24 is a schematic of a first panel utilized in the tablet computer of FIG. 1;

FIG. 25 is another schematic of the first panel of FIG. 24;

FIG. 26 is a schematic of a second panel utilized in the tablet computer of FIG. 1;

FIG. 27 is another schematic of the second panel of FIG. 26;

FIG. 28 is a schematic of a portion of the controller assembly of FIG. 20;

FIG. 29 is a schematic of another portion of the controller assembly of FIG. 20;

FIG. 30 is another schematic of a portion of the controller assembly of FIG. 20;

FIG. 31 is a flowchart of a method for coupling first and second computer cables to a tablet computer in accordance with another exemplary embodiment.

### DETAILED DESCRIPTION

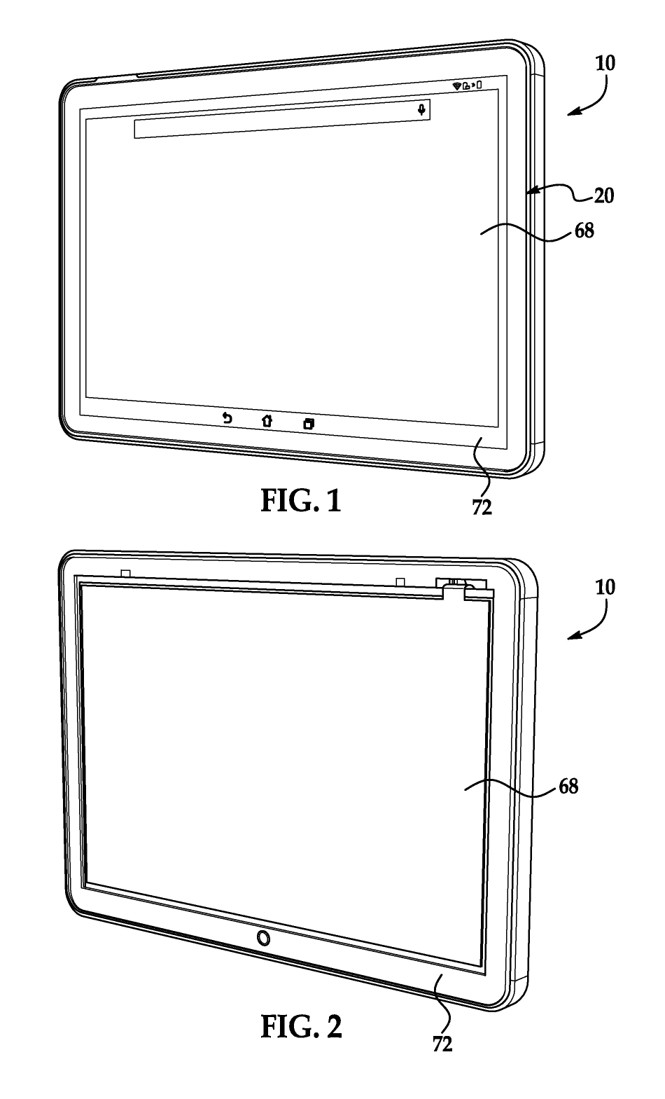

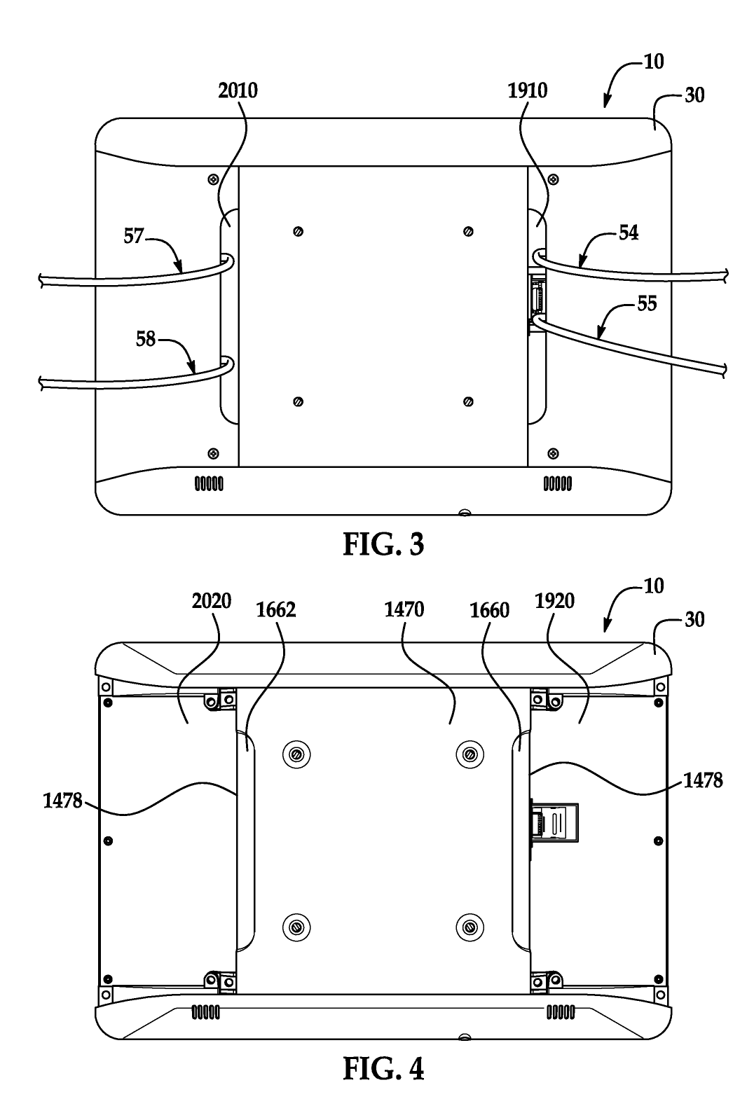

Referring to FIGS. 1, 3, 7, 10 and 11, a tablet computer 10 in accordance with an exemplary embodiment is provided. The tablet computer 10 includes a front display assembly 20, a rear housing 30, a controller assembly 40, a first panel 50, a second panel 52, and computer cables 54, 55, 56, 57, 58. An advantage of the tablet computer 10 is that the tablet computer 10 utilizes the first and second panels 50, 52 are removable from the rear housing 30 to allow a user to couple at least first and second computer cables to first and second I/O port connectors, respectively, that are disposed proximate to and underneath the first and second panels 50, 52, respectively. Thereafter, when the first and second panels 50, 52 are re-attached to the rear housing 30, the first and second panels 50, 52 define first and second elongated apertures 1910, 2010 (shown in FIG. 3) between the panels 50, 52 and a controller housing 1004 which allows the first and second computer cables to extend therethrough while preventing access to the first and second I/O port connectors.

Referring to FIGS. 1, 2, 10 and 13-15, the front display assembly 20 is provided to display images thereon. In an exemplary embodiment, the front display assembly 20 includes a glass panel 60, a touch panel 64, a display device 68, a display chassis 72, a gasket 76, and a PCB assembly 80. In an alternative embodiment, the front display assembly 20 could comprise the display device 68. In still another alternative embodiment, the front display assembly 20 could comprise the display device 68 and the touch panel 64.

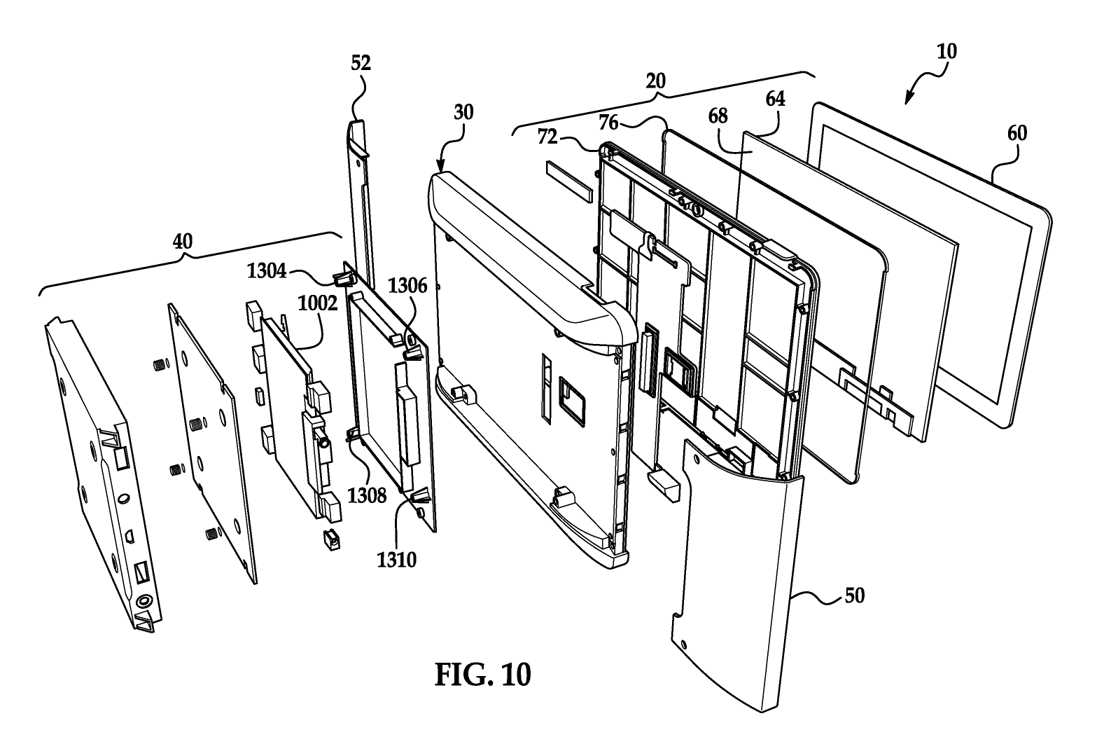

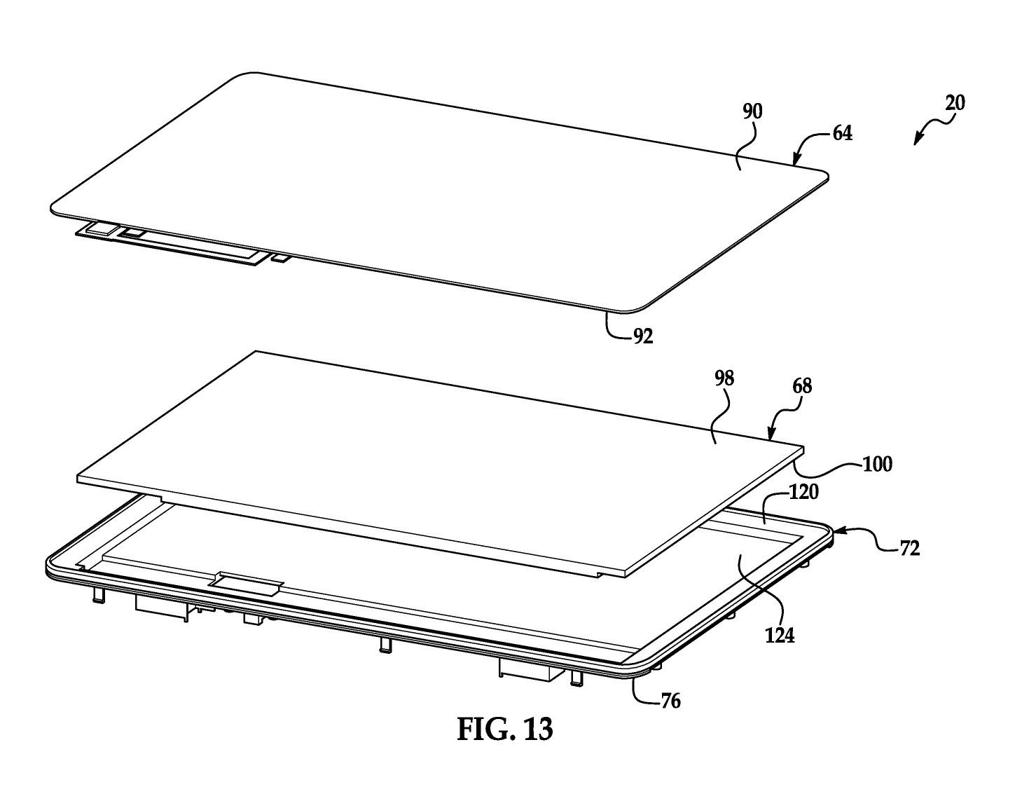

Referring to FIGS. 10 and 13, the glass panel 60 is constructed of a substantially transparent glass. The glass panel 60 is coupled to a first side 90 of the touch panel 64.

The touch panel 64 is adapted to detect a position of a region on the glass panel 60 touched by a user, and to generate a signal indicative of the touched region. The touch panel 64 is disposed between the glass panel 60 and the display device 68. In particular, the touch panel 64 has a first side 90 and a second side 92 disposed opposite to the first side 90. The first side 90 of the touch panel 64 is coupled to the glass panel 60, and the second side 92 of the touch panel 64 is coupled to the first side 98 of the display device 68.

The display device 68 is provided to display digital images thereon. As shown, the display device 68 is disposed between the touch panel 60 and the display chassis 72. In particular, the display device 68 has a first side 98 and a second side 100 disposed opposite to the first side 98. Further, the first side 98 of the display device 68 is coupled to the second side 92 of the touch panel 64, and the second side 98 of the display device 68 is coupled to the first side 120 of the display chassis 72.

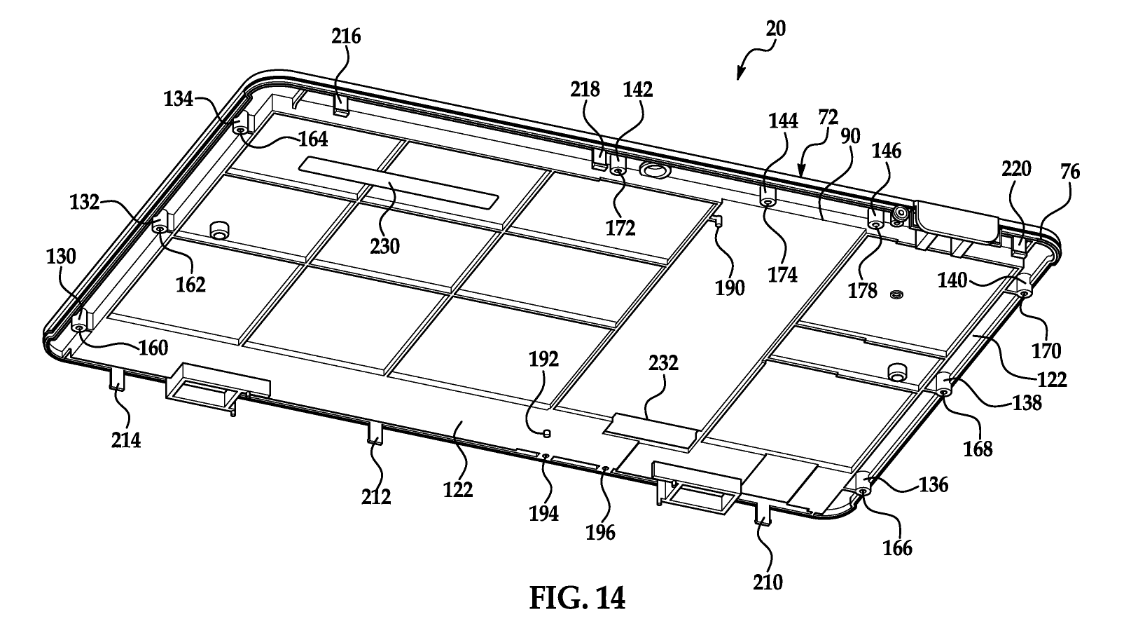

Referring to FIGS. 13 and 14, the display chassis 72 is provided to hold the display device 68, the gasket 76, and the PCB assembly 80 thereon. In an exemplary embodiment, the display chassis 72 is constructed of plastic. The display chassis 72 includes a substrate 90, studs 130, 132, 134, 136, 138, 140, 142, 144, 146, 190, 192, 194, and coupling members 210, 212, 214, 216, 218, 220. The substrate 90 has a first side 120 (shown in FIG. 13) and a second side 122 (shown in FIG. 14), and apertures 230, 232 extending therethrough.

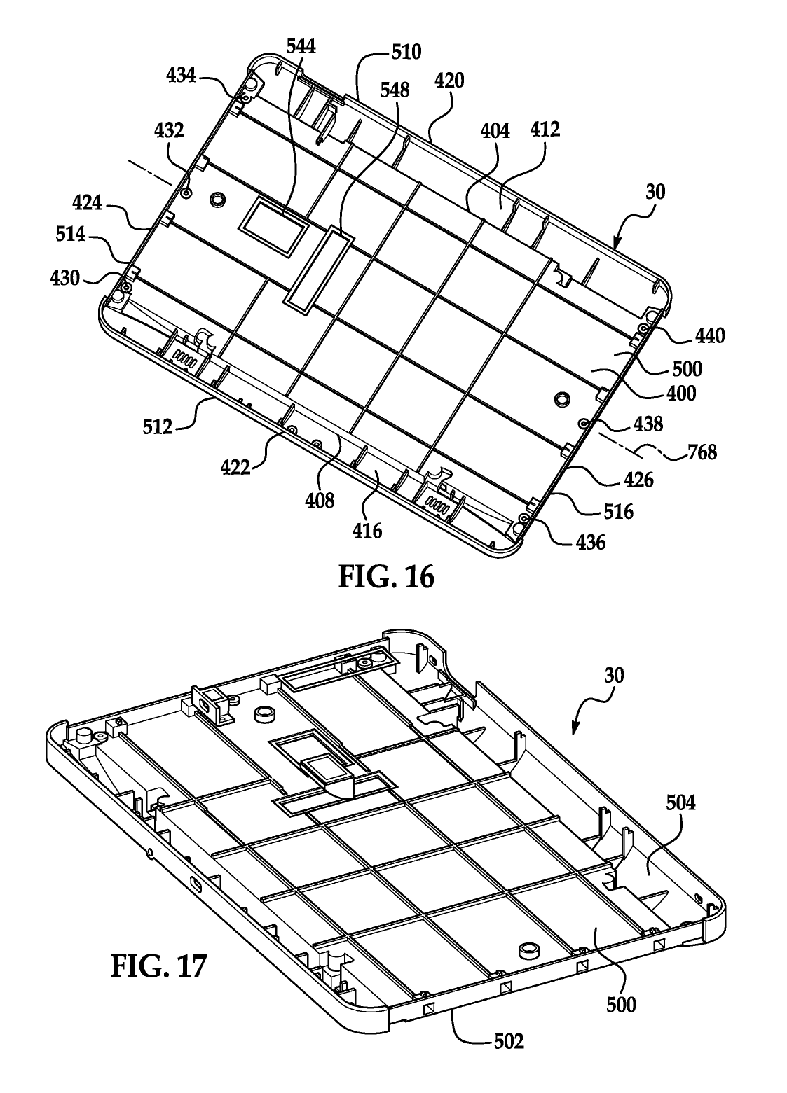

Referring to FIGS. 14 and 16, the studs 130, 132, 134, 136, 138, 140 of the display chassis 72 extend outwardly from the second side 122. The studs 130, 132, 134, 136, 138, 140 include apertures 160, 162, 164, 166, 168, 170, 172, 174, 176, respectively, extending therein. The bolts 256, 258, 260, 250, 252, 254 extend through the apertures 436, 438, 440, 430, 432, 434 (shown in FIG. 16), respectively, of the rear housing 30 and into the apertures 160, 162, 164, 166, 168, 170, 172, 174, 176 (shown in FIG. 14), respectively, of the display chassis 72 for coupling the display chassis 72 to the rear housing 30.

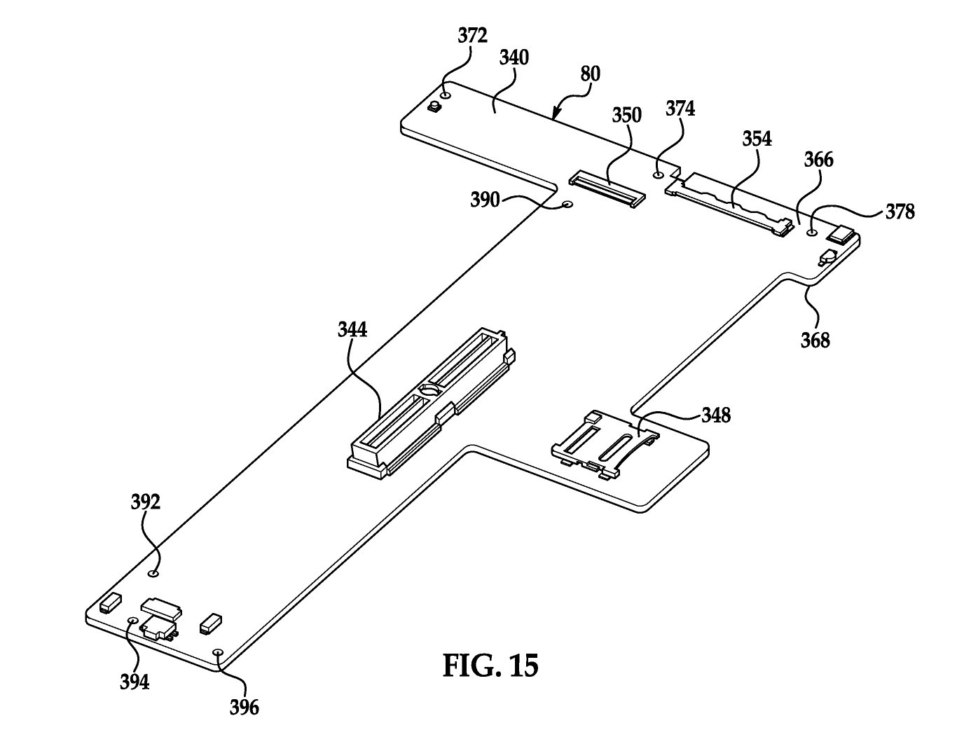

Referring to FIGS. 14 and 15, the studs 142, 144, 146 of the display chassis 72 extend outwardly from the second side 122. The studs 142, 144, 146 include apertures 172, 174, 176, respectively, extending therein. Corresponding bolts extend through the apertures 372, 374, 378 (shown in FIG. 15) of the PCB assembly 340 and into the apertures 172, 174, 176 for coupling the PCB assembly 80 to the display chassis 72. The studs 190, 192, 194, 196 (shown in FIG. 14) are received within the apertures 390, 392, 394, 396 (shown in FIG. 15), respectively, to further couple the PCB assembly 80 to the display chassis 72. Referring to FIG. 14, the coupling members 210, 212, 214, 216, 218, 220 of the display chassis 72 are provided to engage corresponding grooves within the rear housing 30 for coupling the display chassis 72 to the rear housing 30.

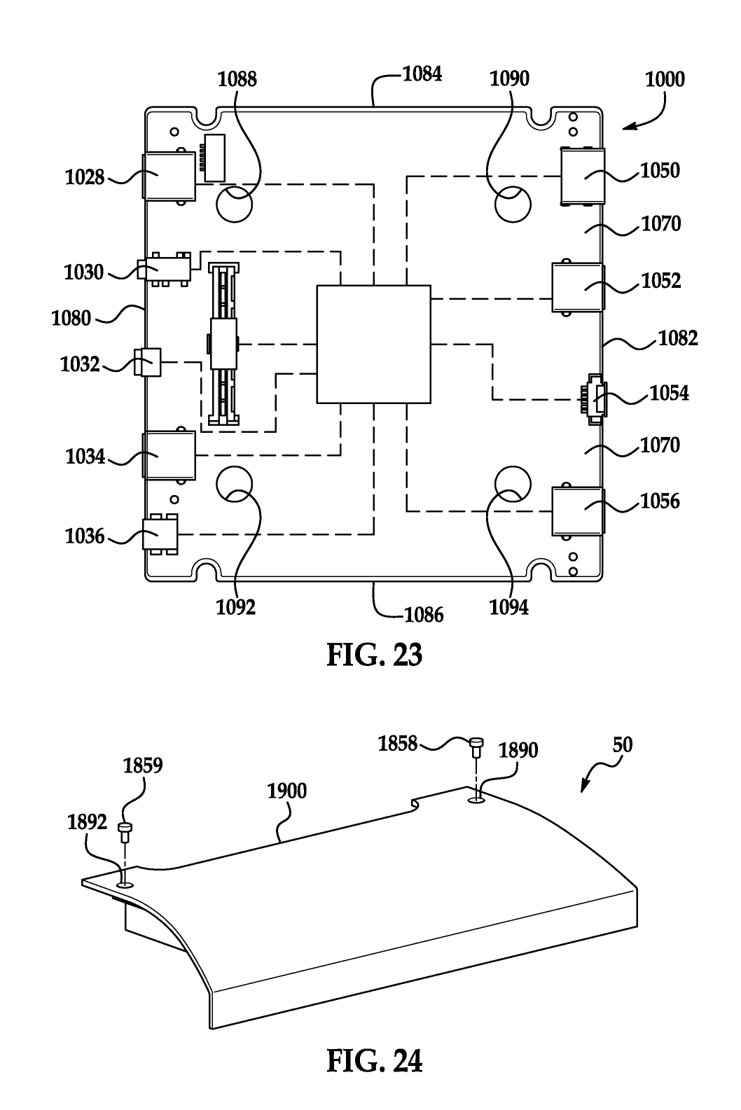

Referring to FIGS. 10 and 15, the PCB assembly 80 is provided to electrically couple the microprocessor 1024 (shown in FIG. 23) of the controller assembly 40 to the touch panel 64 and the display device 68. The PCB assembly 80 includes a PCB 340, an electrical connector 344, an SD card reader 348, and electrical connectors 350, 354.

The PCB 340 includes a first side 366 and a second side 368 disposed opposite to the first side 366. The PCB 340 is provided to hold the electrical connector 340, the SD card reader 348, and the electrical connectors 350, 354 on the first side 366. The PCB 340 further includes the apertures 372, 374, 378, 390, 392, 394, 396 extending therethrough.

The electrical connector 344 is electrically coupled to the electrical connectors 350, 354, and to the SD card reader 348. The electrical connector 350 is further electrically coupled to the touch panel 64. Also, the electrical connector 354 is further electrically coupled to the display device 68.

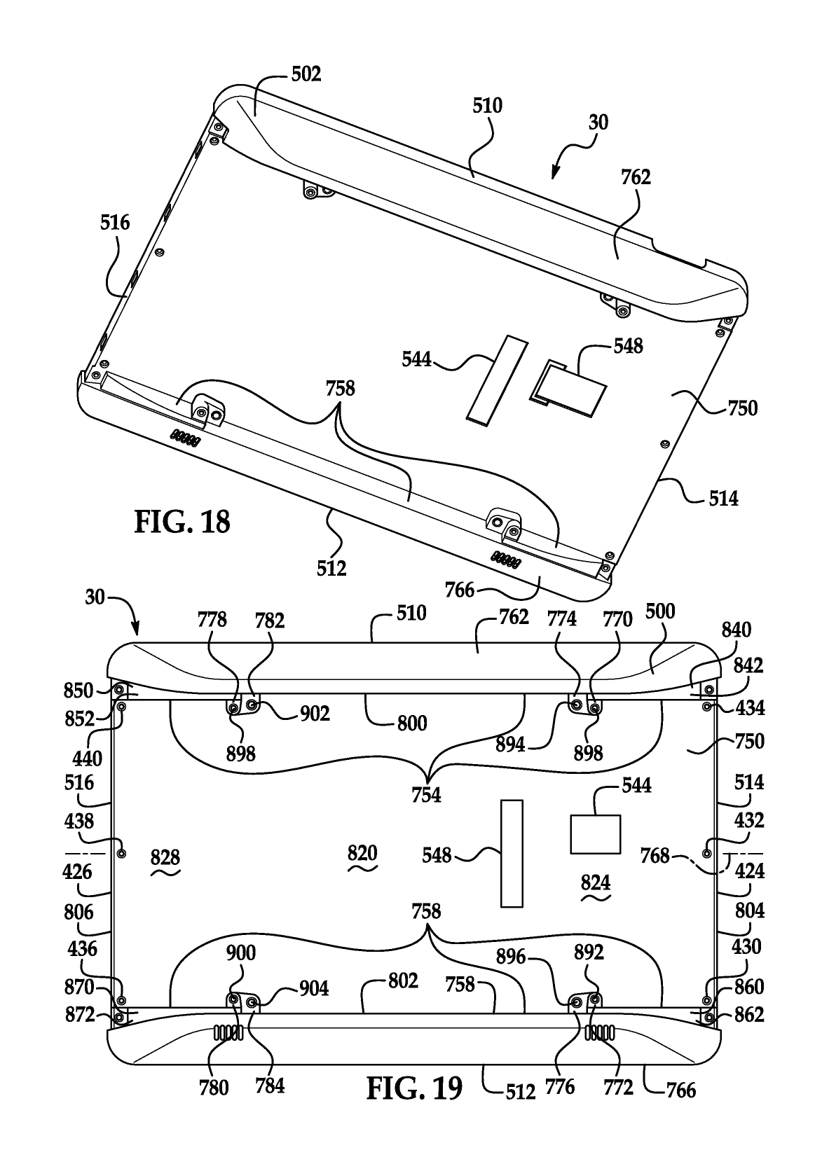

Referring to FIGS. 10 and 16-19, the rear housing 30 is provided to hold the front display assembly 20, the controller assembly 40, and the first and second panels 50, 52 thereon. In an exemplary embodiment, the rear housing 30 is constructed of plastic. The rear housing 30 includes a rear wall 400, first and second riser walls 404, 408, substantially arcuate-shaped peripheral walls 412, 416, and side walls 420, 422, 424, 426. Referring to FIGS. 16 and 18, the rear housing 30 further includes a first side 500 (shown in FIG. 16) and a second side 502 (shown in FIG. 18). Further, the rear housing 30 further includes first, second, third, fourth outer ends 510, 512, 514, 516.

The first and second outer ends 510, 512 are substantially parallel to one another, and the third and fourth outer ends 514, 516 are substantially parallel to one another and perpendicular to the first and second outer ends 510, 512, respectively, thereof.

The rear wall 400 of the rear housing 30 extends along a longitudinal axis 768. The rear wall 400 includes apertures 544, 548 extending therethrough, for allowing the SD card reader 348 (shown in FIG. 15) and the electrical connector 344 (shown in FIG. 23), respectively, to extend therethrough. The rear wall 400 further includes apertures 430, 432, 434, 436, 438, 440 extending therethrough for receiving corresponding bolts therethrough for coupling the rear housing 30 to the front display assembly 20.

The first and second riser walls 404, 408 of the rear housing 30 extend from first and second ends, respectively, of the rear wall 400 in a first direction substantially perpendicular to the rear wall 400. The first and second riser walls 404, 408 extend substantially an entire longitudinal length of the rear housing 30.

The substantially arcuate-shaped peripheral wall 412 of the rear housing 30 is disposed away from the rear wall 400 and extends from an end of the first riser wall 404 in a second direction substantially perpendicular to the longitudinal axis 768. Further, the substantially arcuate-shaped peripheral wall 412 extends substantially an entire longitudinal length of the rear housing 30 substantially parallel to the substantially arcuate-shaped peripheral wall 416. Further, the substantially arcuate-shaped peripheral wall 416 of the rear housing 30 is disposed away from the rear wall 400 and extends from an end of the second riser wall 408 in a third direction substantially perpendicular to the longitudinal axis 768. Further, the substantially arcuate-shaped peripheral wall 416 extends substantially an entire longitudinal length of the rear housing 30.

The side wall 420 of the rear housing 30 extends from an end of the arcuate-shaped peripheral wall 412 in a fourth direction through a plane defined by the rear wall 400. Also, the side wall 422 extends from an end of the arcuate-shaped peripheral wall 416 in the fourth direction.

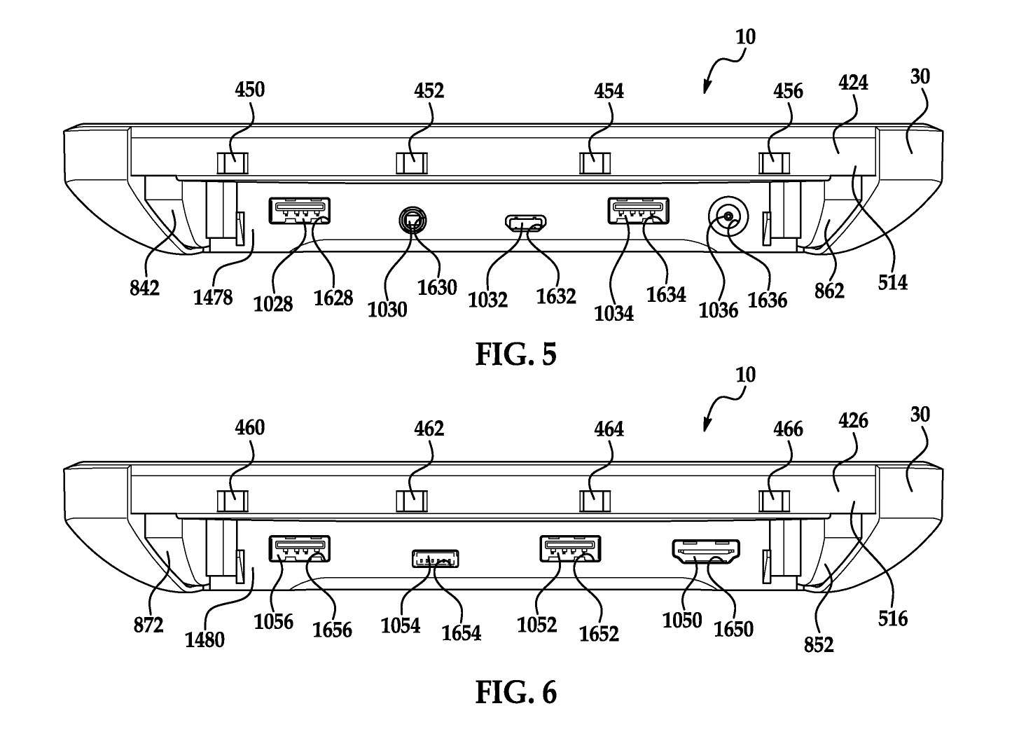

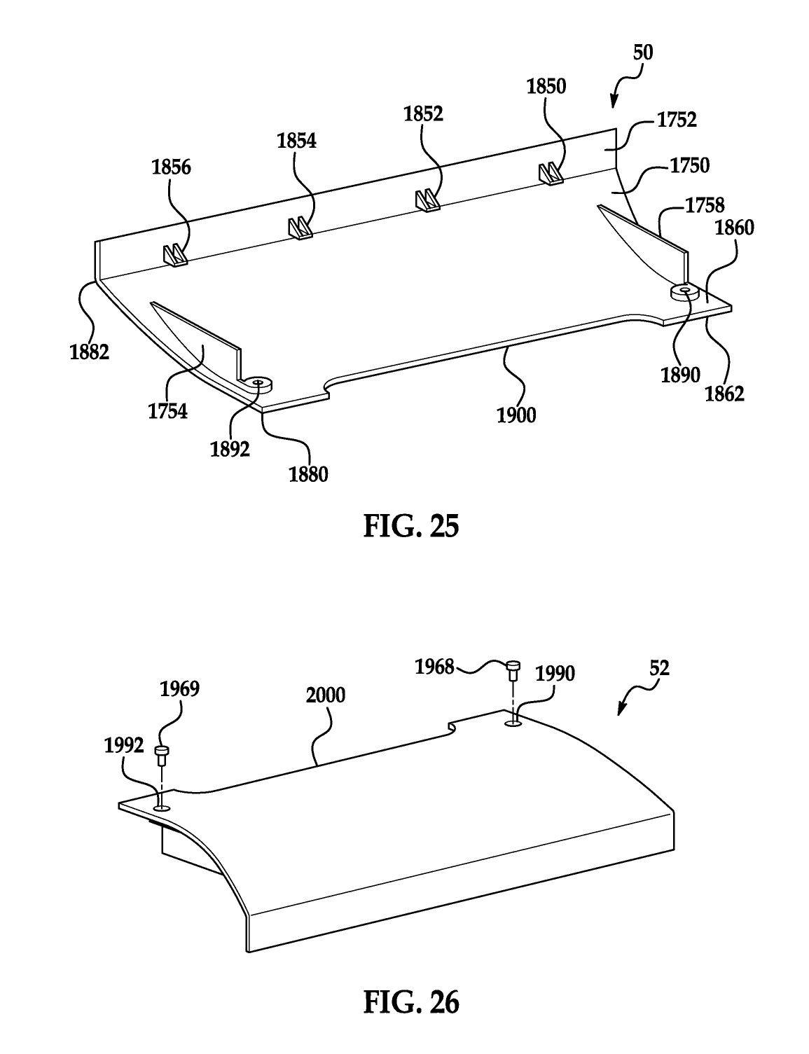

Referring to FIGS. 5 and 16, the side wall 424 extends from an outer end 514 of the rear housing 30 in the fourth direction. The side wall 424 includes grooves 450, 452, 454, 456 extending therein for receiving coupling members 1850, 1852, 1854, 1856, respectively, (shown in FIG. 25) of the first panel 50 for coupling the first panel 50 to the rear housing 30.

Referring to FIGS. 6 and 16, the side wall 426 extends from an outer end 516 of the rear housing 30 in the fourth direction. The side wall 426 includes grooves 460, 462, 464, 466 extending therein for receiving coupling members 1960, 1962, 1964, 1966, respectively, (shown in FIG. 26) of the second panel 52 therein for coupling the second panel 52 to the rear housing 30.

Referring to FIGS. 10 and 17, the first side 500 of the rear housing 30 defines an interior region 504 (shown in FIG. 17) for receiving the front display assembly 20 therein. The front display assembly 20 is coupled to the first side 500.

Referring to FIGS. 16, 18 and 19, the second side 502 of the rear housing 30 has a substantially flat surface 750, first and second riser surfaces 754, 758, first and second peripheral surfaces 762, 766, and studs 770, 772, 774, 776, 778, 780, 782, 784. In particular, the rear wall 400 defines the substantially flat surface 750. Further, the first and second riser walls 404, 408 define the first and second riser surfaces 754, 758, respectively. Also, the arcuate-shaped peripheral walls 412, 416 define the first and second peripheral surfaces 762, 766, respectively.

Referring to FIGS. 18 and 19, the substantially flat surface 750 of the rear housing 30 extends along the longitudinal axis 768 and has first, second, third, and fourth ends 800, 802, 804, 806. The first and second ends 800, 802 are substantially parallel to one another. The third and fourth ends 804, 806 are substantially parallel to one another and are further substantially perpendicular to the first and second ends 800, 802. The substantially flat surface 750 includes regions 820, 824, 828 that are sized and shaped to receive the controller assembly 40, the first panel 50, the second panel 52, respectively, therein.

The first and second riser surfaces 754, 758 of the rear housing 30 extend from the first and second ends 800, 802, respectively, of the substantially flat surface 750 in a direction substantially perpendicular to the substantially flat surface 750.

The first and second peripheral surfaces 762, 766 of the rear housing 30 are disposed away from the substantially flat surface 750 and extend from first and second riser surfaces 754, 758, respectively, to the first and second outer ends 510, 512, respectively, of the rear housing 30. The first and second peripheral surfaces 762, 766 further extend longitudinally and substantially parallel to one another.

The first peripheral surface 762 and the first riser surface 754 have a groove 840 extending therein that defines a panel receiving surface 842. The panel receiving surface 842 is disposed proximate to the third outer end 514 of the rear housing 30. Further, the first peripheral surface 762 and the first riser surface 754 have a groove 850 extending therein that defines a panel receiving surface 852. The panel receiving surface 852 is disposed proximate to the fourth outer end 516 of the rear housing 30.

The second peripheral surface 766 and the second riser surface 758 have a groove 860 extending therein that defines a panel receiving surface 862. The panel receiving surface 862 is disposed proximate to the third outer end 514 of the rear housing 30. Further, the second peripheral surface 762 and the second riser surface 758 have a groove 870 extending therein that defines a panel receiving surface 872. The panel receiving surface 872 is disposed proximate to the fourth outer end 516 of the rear housing 30.

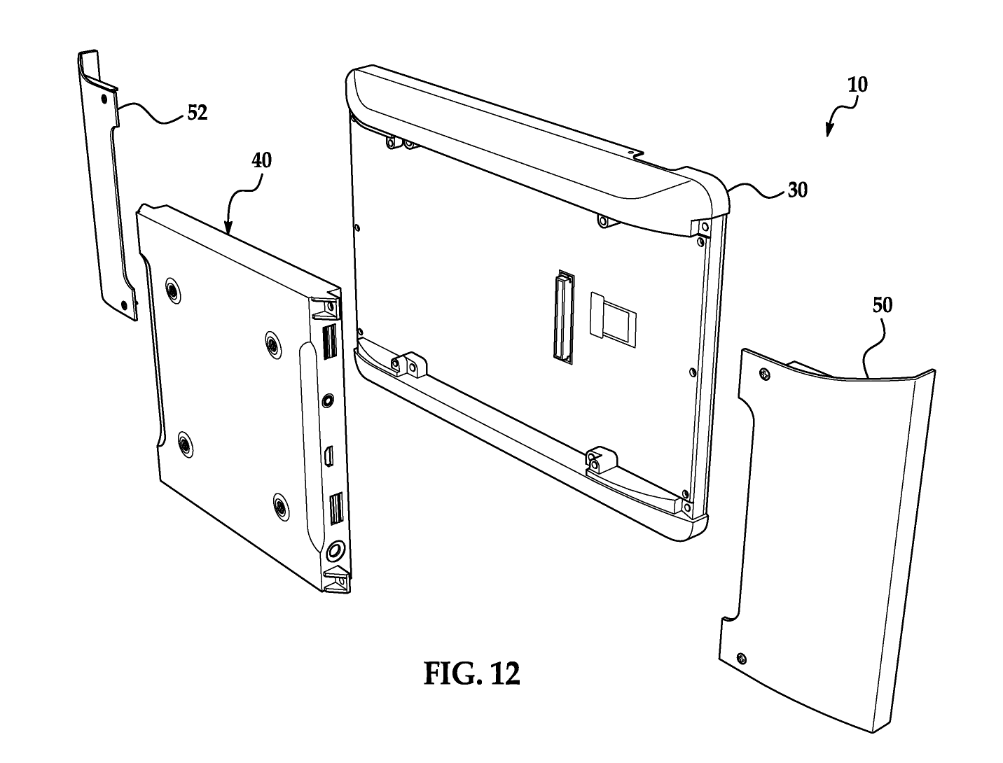

Referring to FIGS. 12 and 19, when the panel 50 is attached to the rear housing 30, the panel 50 is disposed on the panel receiving surfaces 842, 862. Further, when the panel 52 is attached to the rear housing 30, the panel 52 is disposed on the panel receiving surfaces 852, 872.

Referring to FIGS. 19 and 24, the studs 770, 772 of the rear housing 30 are provided to support and to be coupled to the first panel 50. The studs 770, 772 are disposed on and extend outwardly from the substantially flat surface 750 between the panel receiving surfaces 842, 862, respectively. The studs 770, 772 are further disposed proximate to the panel receiving surfaces 842, 862, respectively. The studs 770, 772 have apertures 890, 892, respectively, extending therein for receiving bolts 1858, 1859, respectively, therein for coupling the first panel 50 to the rear housing 30. In particular, the bolt 1858 extends through an aperture 1890 in the panel 50 and further into the aperture 890 of the stud 770 for coupling the first panel 50 to the rear housing 30. Further, the bolt 1859 extends through an aperture 1892 in the panel 50 and further into the aperture 892 of the studs 772 for coupling the first panel 50 to the rear housing 30.

Referring to FIGS. 19 and 26, the studs 778, 780 of the rear housing 30 are provided to be coupled to the second panel 52. The studs 778, 780 are disposed on the substantially flat surface 750 between the panel receiving surfaces 852, 872, respectively. The studs 778, 780 are further disposed proximate to the panel receiving surfaces 852, 872, respectively. The studs 778, 780 have apertures 898, 900, respectively, extending therein for receiving bolts 1969, 1968, respectively, therein for coupling the second panel 52 to the rear housing 30. In particular, the bolt 1969 extends through an aperture 1992 in the panel 52 and further into the aperture 898 of the studs 778 for coupling the second panel 52 to the rear housing 30. Further, the bolt 1968 extends through an aperture 1990 in the panel 52 and further into the aperture 900 of the studs 780 for coupling the second panel 52 to the rear housing 30.

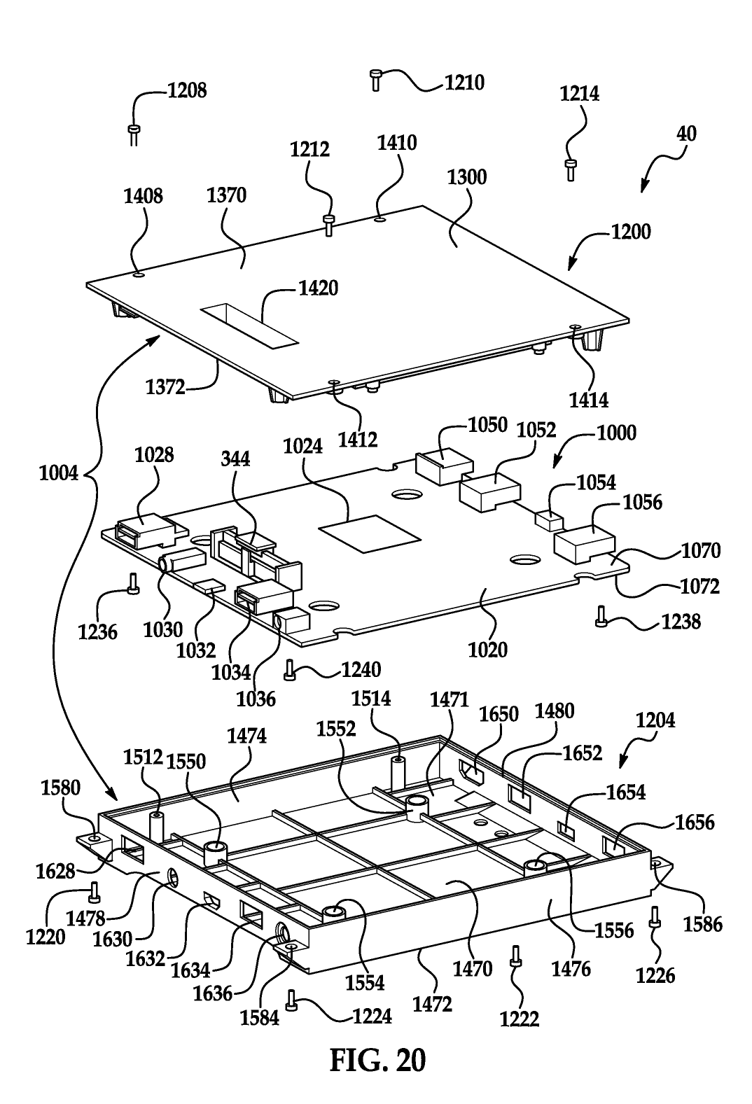

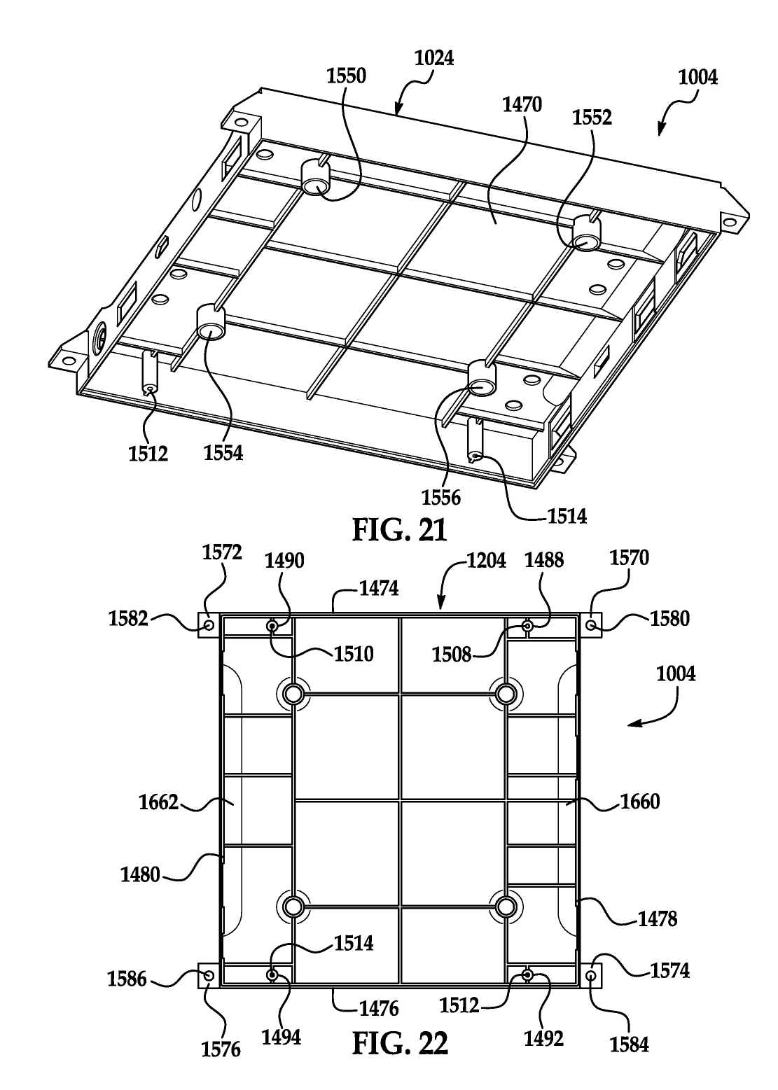

Referring to FIGS. 19 and 20, the studs 774, 776, 782, 784 of the rear housing 30 are provided to support and to be coupled to the controller assembly 40. The studs 774, 776, 782, 784 are disposed on the substantially flat surface 750 in the region 820. The studs 774, 776, 782, 784 include apertures 894, 896, 902, 904, respectively, extending therein for receiving bolts 1220, 1224, 1222, 1226 (shown in FIG. 20) respectively, therein for coupling the controller assembly 40 to the rear housing 30. In particular, the bolt 1220 extends through an aperture 1580 (shown in FIG. 22) in the controller housing 40 and further into the aperture 894 (shown in FIG. 19) of the stud 774. Further, the bolt 1222 extends through an aperture 1582 (shown in FIG. 22) in the controller housing 40 and further into the aperture 902 (shown in FIG. 19) of the stud 782. Further, the bolt 1224 extends through an aperture 1584 (shown in FIG. 22) in the controller housing 40 and further into the aperture 896 (shown in FIG. 19) of the stud 776. Further, the bolt 1226 extends through an aperture 1586 (shown in FIG. 22) in the controller housing 40 and further into the aperture 904 (shown in FIG. 19) of the stud 784.

Referring to FIGS. 10 and 20-23, the controller assembly 40 is provided to control operation of the touch panel 64 and the display device 68 via the electrical connector 344 (shown in FIG. 20). The controller assembly 40 includes the PCB assembly 1000, a battery 1002, and a controller housing 1004.

Referring to FIGS. 5, 6, 10, 20 and 23, the PCB assembly 1000 includes a PCB 1020, a microprocessor 1024, and I/O port connectors 1028, 1030, 1032, 1034, 1036, 1050, 1052, 1054, 1056.

The PCB 1020 includes a first side 1070 (shown in FIG. 23) and a second side 1072 disposed opposite to the first side 1070. The PCB 1020 further includes edges 1080, 1082, 1084, 1086 (shown in FIG. 23). The edges 1080, 1082 are disposed apart from one another and extend substantially parallel to one another. Also, the edges 1084, 1086 are disposed part from one another and extend substantially parallel to one another and substantially perpendicular to the edges 1080, 1082. The PCB 1020 further includes apertures 1088, 1090, 1092, 1094 extending therethrough.

The microprocessor 1024 is coupled to the first side 1070 of the PCB 1020. The microprocessor 1024 is electrically coupled to the I/O port connectors 1028, 1030, 1032, 1034, 1036, 1050, 1052, 1054, 1056 and to the battery 1022. The battery 1022 provides an operational voltage to the microprocessor 1024 and the front display assembly 20.

The I/O port connectors 1028, 1030, 1032, 1034, 1036 are disposed on the first side 1070 of the PCB 1022 proximate to the edge 1080. Also, the I/O port connectors 1050, 1052, 1054, 1056 are disposed on the first side 1070 of the PCB 1022 proximate to the edge 1082.

Referring to FIGS. 20 and 23, the apertures 1088, 1090, 1092, 1094 in the PCB 1020 are provided to receive the positioning members 1550, 1552, 1554, 1556 (shown in FIG. 20), respectively, therethrough for positioning the PCB 1020 in the controller housing 1004.

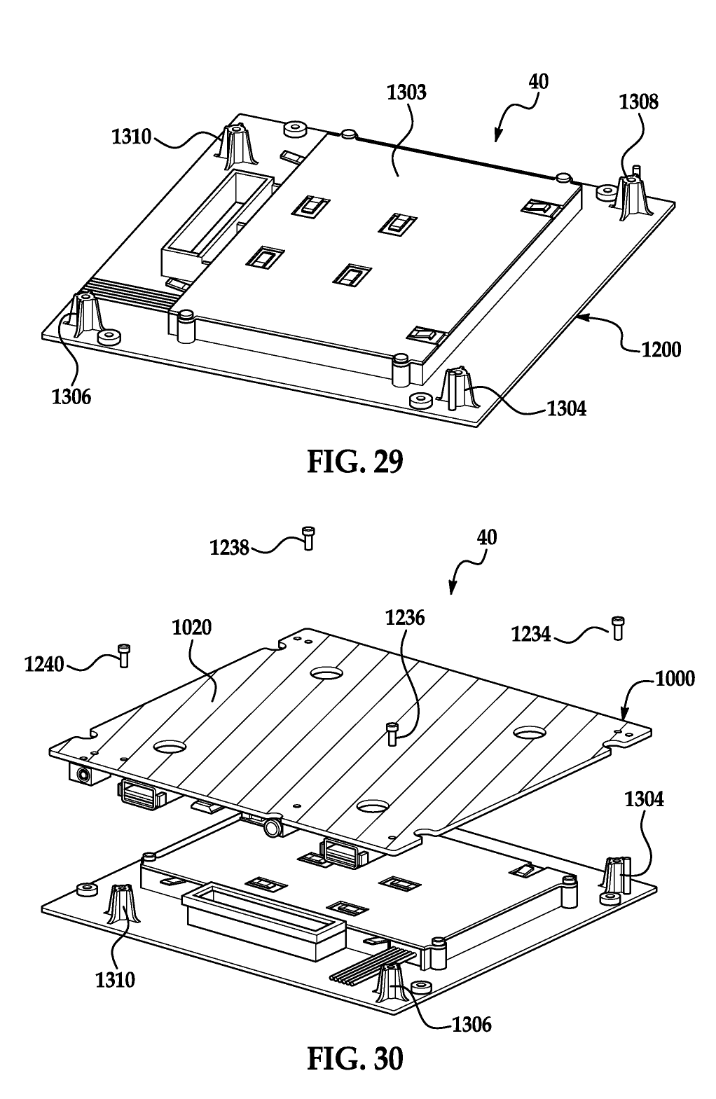

Referring to FIGS. 20 and 29, the controller housing 1004 is provided to hold the PCB assembly 1000 therein. The controller housing 1004 includes a cover plate 1200, a housing portion 1204, bolts 1208, 1210, 1212, 1214, bolts 1220, 1222, 1224, 1226, and bolts 1234, 1236, 1238, 1240.

Referring to FIGS. 28-30, the cover plate 1200 is provided to be coupled to the housing portion 1204 to hold the PCB assembly 1000 and the battery 1002 within an interior region defined by the cover plate 1200 and housing portion 1204. In an exemplary embodiment, the cover plate 1200 is constructed of plastic. The cover plate 1200 includes a plate portion 1300, a battery receiving portion 1302, and positioning studs 1304, 1306, 1308, 1310 (shown in FIG. 10) each having an aperture extending therein.

The plate portion 1300 includes a first side 1370 and a second side 1372 disposed opposite to the first side 1370. The plate portion 1300 further includes apertures 1408, 1410, 1412, 1414 extending therethrough. The apertures 1408, 1410, 1412, 1414 are configured to receive the bolts 1208, 1210, 1212, 1214, respectively, therethrough for coupling the cover plate 1200 to the housing portion 1204. The aperture 1420 is configured to receive the electrical connector 344 (shown in FIG. 20) of the PCB assembly 1000 therethrough. The bolts 1234, 1236, 1238, 1240 extend through corresponding apertures in the PCB 1020 and into corresponding apertures in the positioning studs 1304, 1306, 1308, 1310, respectively, to couple the PCB assembly 1000 to the cover plate 1200. The battery receiving portion 1302 receives the battery 1002 therein. A battery cover plate 1303 is disposed on the battery 1002 and coupled to the battery receiving portion 1302 to hold the battery 1002 therein.

Referring to FIGS. 20-22, the housing portion 1204 includes a rear wall 1470, side walls 1474, 1476, 1478, 1480, studs 1488, 1490, 1492, 1494, positioning members 1550, 1552, 1554, 1556, and extension portions 1570, 1572, 1574, 1576.

The rear wall 1470 of the housing portion 1204 includes a first side 1471 and a second side 1472. The side walls 1474, 1476, 1478, 1480 are coupled to and extend substantially perpendicular to the first side of the rear wall 1470. The side walls 1474, 1476 are disposed apart from one another and extending substantially parallel to one another. The side walls 1478, 1480 are disposed apart from one another and extending substantially parallel to one another.

Referring to FIG. 20, the side wall 1478 of the housing portion 1204 includes apertures 1628, 1630, 1632, 1634, 1636 that communicate with the I/O port connectors 1028, 1030, 1032, 1034, respectively, such that the I/O port connectors 1028, 1030, 1032, 1034 are accessible through the apertures 1628, 1630, 1632, 1634, 1636, respectively.

The side wall 1480 of the housing portion 1204 includes apertures 1650, 1652, 1654, 1656 that communicate with the I/O port connectors 1050, 1052, 1054, 1056, respectively, such that the I/O port connectors 1050, 1052, 1054, 1056 are accessible through the apertures 1650, 1652, 1654, 1656, respectively.

Referring to FIGS. 20 and 22, the studs 1488, 1490, 1492, 1494 of the housing portion 1204 have apertures 1508, 1510, 1512, 1514, respectively, extending therein for receiving the bolts 1208, 1210, 1212, 1214 (shown in FIG. 20), respectively, for coupling the cover plate 1200 to the housing portion 1204. In particular, the bolt 1208 extends through the aperture 1408 of the cover plate 1200 and into the aperture 1508. Further, the bolt 1210 extends through the aperture 1410 of the cover plate 1200 and into the aperture 1510. Further, the bolt 1212 extends through the aperture 1412 of the cover plate 1200 and into the aperture 1512. Further, the bolt 1214 extends through the aperture 1414 of the cover plate 1200 and into the aperture 1514.

The positioning members 1550, 1552, 1554, 1556 of the housing portion 1204 extend outwardly from the first side 1471 of the rear wall 1470. The positioning members 1550, 1552, 1554, 1556 are configured to be received through the apertures 1088, 1090, 1092, 1094 (shown in FIG. 23), respectively, of the PCB 1020.

Referring to FIGS. 19, 20 and 22, the extension portions 1570, 1574 of the housing portion 1204 are coupled to and extend outwardly from the side wall 1478. The extension portions 1570, 1574 have apertures 1580, 1584, respectively, extending therethrough for receiving bolts 1220, 1224, respectively, therethrough which further extend into the apertures 894, 896 (shown in FIG. 19), respectively, in the studs 774, 776, respectively, of the rear housing 30. Further, the extension portions 1572, 1576 are coupled to and extend outwardly from the side wall 1480. The extension portions 1572, 1576 have apertures 1582, 1586, respectively, extending therethrough for receiving bolts 1222, 1226, respectively, therethrough which further extend into the apertures 902, 904 (shown in FIG. 19), respectively, in the studs 782, 784, respectively, of the rear housing 30.

Referring to FIGS. 5, 8, 19, 24 and 25, the first panel 50 is provided to cover a region 824 (shown in FIG. 19) of the rear housing 30. When the first panel 50 is coupled to the rear housing 30, both the first panel 50 and the side wall 1478 (shown in FIG. 20) of the controller housing 1004 define an elongated aperture 1910 (shown in FIG. 3) for allowing cable portions of computer cables to extend therethrough. In particular, the groove 1900 (shown in FIG. 24) in the first panel 50, and the groove 1660 (shown in FIG. 4) in both the side wall 1478 and the rear wall 1470 of the controller housing 1004, define the elongated aperture 1910 (shown in FIG. 3). In an alternative embodiment, the elongated aperture 1910 could be replaced with a plurality of apertures. Further, the first panel 50, the second side 502 of the rear housing 30, and the side wall 1478 of the controller housing 1004 define a first interior space 1920 (shown in FIG. 4) for holding connectors of computer cables entirely therein. The first panel 50 prevents unauthorized users from easily accessing the I/O port connectors of the controller assembly 40 and the connectors of computer cables. Thus, the first panel 50 provides a level of security with respect to the I/O port connectors of the control assembly 40. In an exemplary embodiment, the first panel 50 is constructed of plastic. Referring to FIGS. 25 and 26, the first panel 50 includes panel portions 1750, 1752, guiding members 1754, 1758, coupling members 1850, 1852, 1854, 1856, and bolts 1858, 1859. The panel portions 1750, 1752 define a first side 1860 and a second side 1862.

The panel portion 1750 is substantially arcuate-shaped and includes a first end 1880 and a second end 1882. The panel portion 1750 includes a groove 1900 extending into the first end 1880 of the panel portion 1750. The groove 1900 defines at least a portion of the elongated aperture 1910 (shown in FIG. 8) for receiving cable portions of computer cables therethrough. The panel portion 1752 is substantially rectangular-shaped and is coupled to and extends from the second end 1882 of the panel portion 1750. The panel portion 1750 has apertures 1890, 1892 extending therethrough that are configured to receive bolts 1858, 1859, respectively, therethrough. The bolts 1858, 1859 are further received in the stud apertures 890, 892 (shown in FIG. 19), respectively, of the studs 770, 772, respectively, to couple the panel portion 1750 to the rear housing 30.

Referring to FIGS. 19, 24 and 25, when coupling the first panel 50 to the rear assembly 30, the guiding members 1758, 1754 are provided to slide against the first and second riser surfaces 754, 758, respectively, to guide the panel 50 onto the panel receiving surfaces 842, 872. The guiding members 1754, 1758 are coupled to and extend outwardly from the first side 1860 of the panel portion 1750. The guiding members 1754, 1758 extend substantially parallel to one another and substantially perpendicular to the first end 1880 of the panel portion 1750. When the panel portion 1750 is disposed on the panel receiving surfaces 842, 872, the guiding members 1758, 1754 are disposed adjacent to and contact the first and second riser surfaces 754, 758 (shown in FIG. 19), respectively.

Referring to FIGS. 5 and 25, the coupling members 1850, 1852, 1854, 1856 of the first panel 50 are coupled to and extend from the first side 1860 of the panel portion 1752. When the panel portion 1750 is disposed on the panel receiving surfaces 842, 862, the coupling members 1850, 1852, 1854, 1856 are configured to engage the grooves 450, 452, 454, 456, respectively, in the rear housing 30 to further couple the first panel 50 to the rear housing 30.

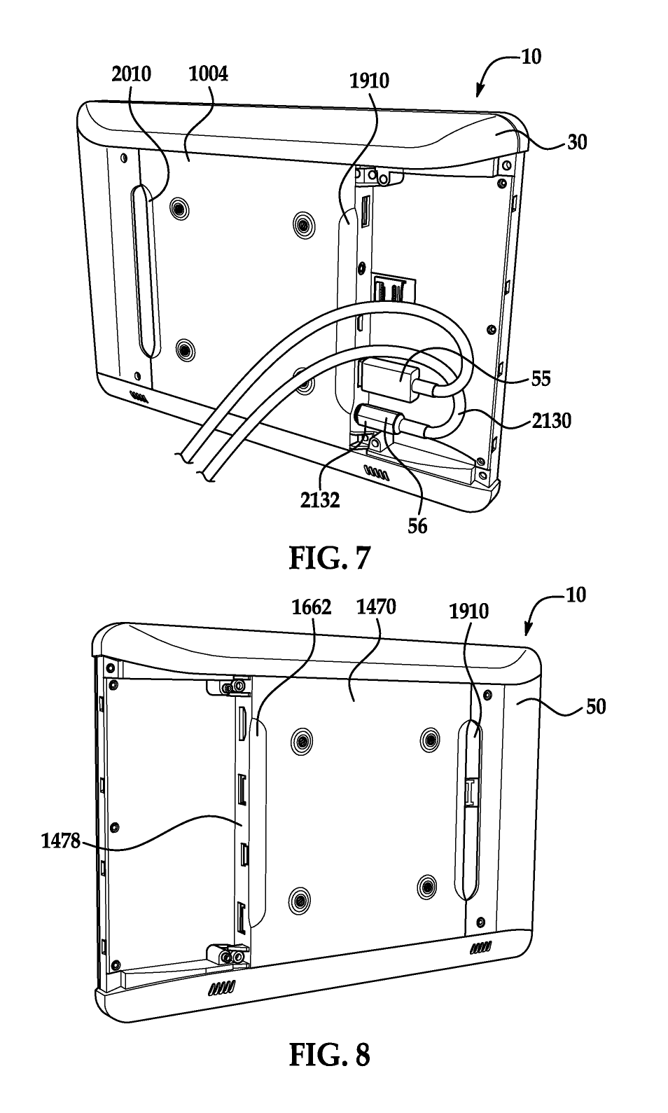

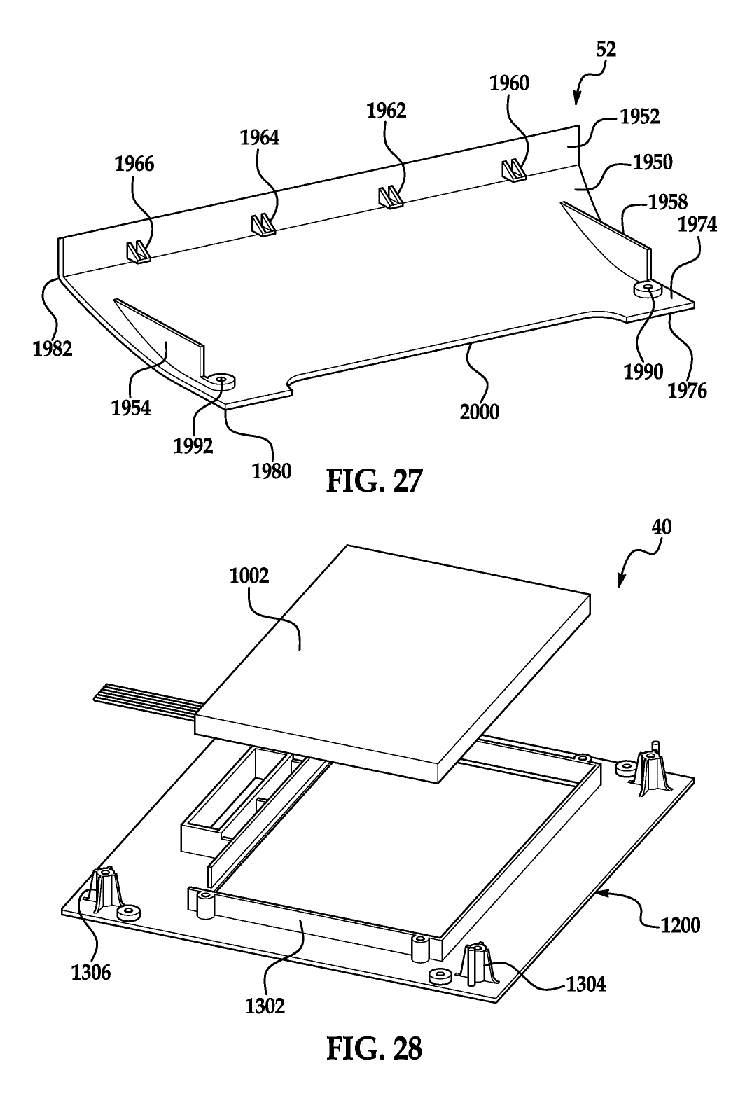

Referring to FIGS. 6, 8, 19, 26 and 27, the second panel 52 is provided to cover a region 828 (shown in FIG. 19) of the rear housing 30. When the second panel 52 is coupled to the rear housing 30, both the second panel 52 and the side wall 1480 (shown in FIG. 20) of the controller housing 1004 define an elongated aperture 2010 (shown in FIG. 7) for allowing cable portions of computer cables to extend therethrough. In particular, the groove 2000 (shown in FIG. 26) in the second panel 52, and the groove 1662 (shown in FIG. 4) in both the side wall 1478 and the rear wall 1470 of the controller housing 1004 define the elongated aperture 2010 (shown in FIG. 7). In an alternative embodiment, the elongated aperture 2010 could be replaced with a plurality of apertures. Further, the second panel 52, the second side 502 of the rear housing 30, and the side wall 1480 of the controller housing 1004 define a second interior space 2020 (shown in FIG. 4) for holding connectors of computer cables entirely therein. The second panel 52 prevents unauthorized users from easily accessing the I/O port connectors of the controller assembly 40 and connectors of computer cables. Thus, the second panel 52 provides a level of security with respect to the I/O port connectors of the control assembly 40. In an exemplary embodiment, the second panel 52 is constructed of plastic. Referring to FIGS. 26 and 27, the second panel 52 includes panel portions 1950, 1952, guiding members 1954, 1958, coupling members 1960, 1962, 1964, 1966, and bolts 1968, 1969. The panel portions 1950, 1952 define a first side 1974 and a second side 1976.

The panel portion 1950 is substantially arcuate-shaped and includes a first end 1980 and a second end 1982. The panel portion 1950 includes a groove 2000 extending into the first end 1980 of the panel portion 1950. The groove 2000 defines at least a portion of the elongated aperture 2010 (shown in FIG. 3) for receiving cable portions of computer cables therethrough. The panel portion 1952 is substantially rectangular-shaped and is coupled to and extends from the second end 1982 of the panel portion 1950. The panel portion 1950 has apertures 1990, 1992 extending therethrough that are configured to receive bolts 1968, 1969, respectively, therethrough. The bolts 1968, 1969 are further received in the stud apertures 900, 898 (shown in FIG. 19), respectively, of the studs 780, 778, respectively, to couple the panel portion 1750 to the rear housing 30.

Referring to FIGS. 19, 26 and 27, when coupling the second panel 52 to the rear assembly 30, the guiding members 1954, 1958 are provided to slide against the first and second riser surfaces 754, 758, respectively, to guide the panel 52 onto the panel receiving surfaces 852, 870. The guiding members 1954, 1958 are coupled to and extend outwardly from the first side 1974 of the panel portion 1950. The guiding members 1954, 1958 extend substantially parallel to one another and substantially perpendicular to the first end 1980 of the panel portion 1950. When the panel portion 1950 is disposed on the panel receiving surfaces 852, 870, the guiding members 1954, 1958 are disposed adjacent to and contact the first and second riser surfaces 754, 758 (shown in FIG. 19), respectively.

Referring to FIGS. 6 and 27, the coupling members 1960, 1962, 1964, 1966 of the second panel 52 are coupled to and extend from the first side 1974 of the panel portion 1952. When the panel portion 1950 is disposed on the panel receiving surfaces 852, 872, the coupling members 1960, 1962, 1964, 1966 are configured to engage the grooves 460, 462, 464, 466, respectively, in the rear housing 30 to further couple the second panel 52 to the rear housing 30.

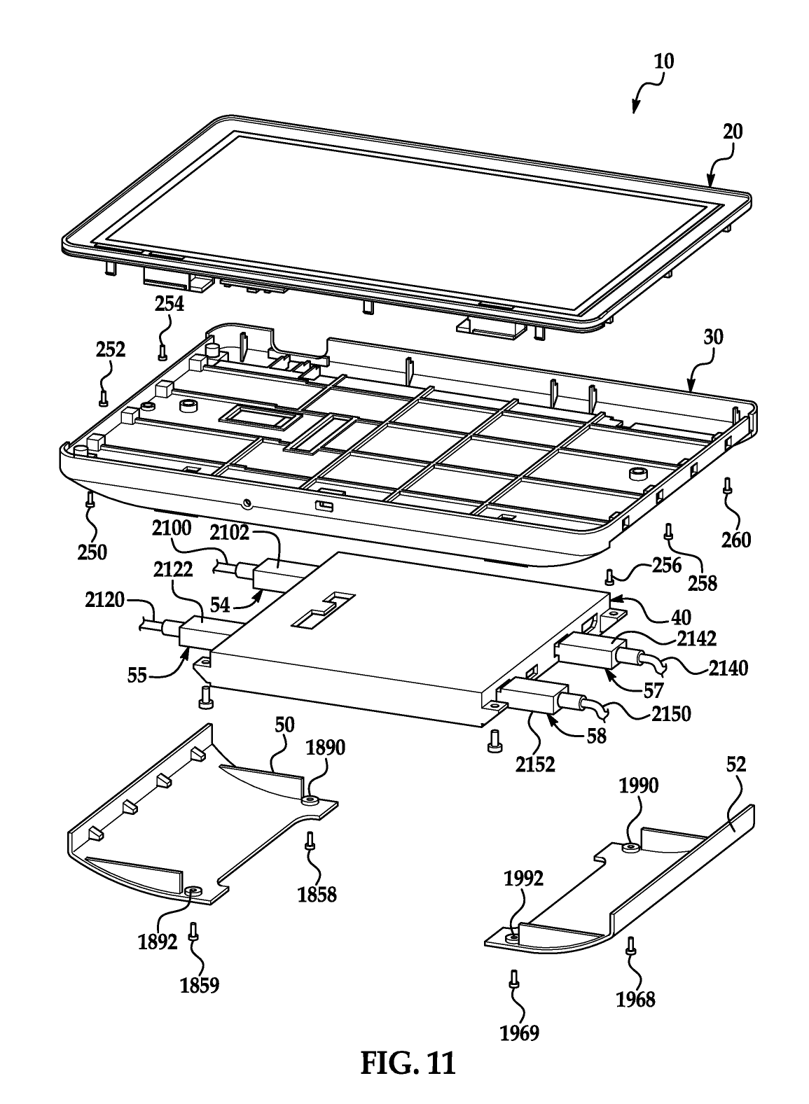

Referring to FIGS. 19 and 23, the computer cable 54 includes a cable portion 2100 and a connector 2102 coupled to the cable portion 2100. The connector 2102 is adapted to be coupled to the I/O port connector 1028. The cable portion 2100 extends through the elongated aperture 1910 (shown in FIG. 3) when the first panel 50 (shown in FIG. 11) is coupled to the rear housing 30.

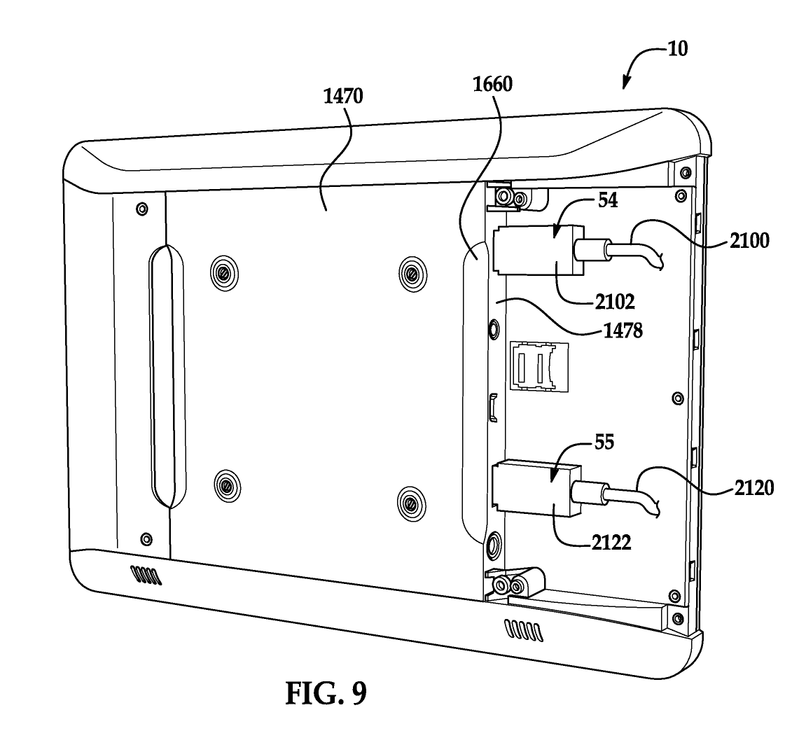

Referring to FIGS. 7, 9 and 23, the computer cable 55 includes a cable portion 2120 and a connector 2122 coupled to the cable portion 2120. The connector 2122 is adapted to be coupled to the I/O port connector 1034. The cable portion 2120 extends through the elongated aperture 1910 (shown in FIG. 3) when the first panel 50 (shown in FIG. 11) is coupled to the rear housing 30.

Referring to FIGS. 7 and 23, the computer cable 56 includes a cable portion 2130 and a connector 2132 coupled to the cable portion 2130. The connector 2132 is adapted to be coupled to the I/O port connector 1036. The cable portion 2130 extends through the elongated aperture 1910 (shown in FIG. 3) when the first panel 50 (shown in FIG. 11) is coupled to the rear housing 30.

Referring to FIGS. 11 and 23, the computer cable 57 includes a cable portion 2140 and a connector 2142 coupled to the cable portion 2140. The connector 2142 is adapted to be coupled to the I/O port connector 1052. The cable portion 2140 extends through the elongated aperture 2010 (shown in FIG. 3) when the second panel 52 (shown in FIG. 11) is coupled to the rear housing 30.

Referring to FIGS. 11 and 23, the computer cable 58 includes a cable portion 2150 and a connector 2152 coupled to the cable portion 2150. The connector 2152 is adapted to be coupled to the I/O port connector 1056. The cable portion 2150 extends through the elongated aperture 2010 (shown in FIG. 3) when the second panel 52 (shown in FIG. 11) is coupled to the rear housing 30.

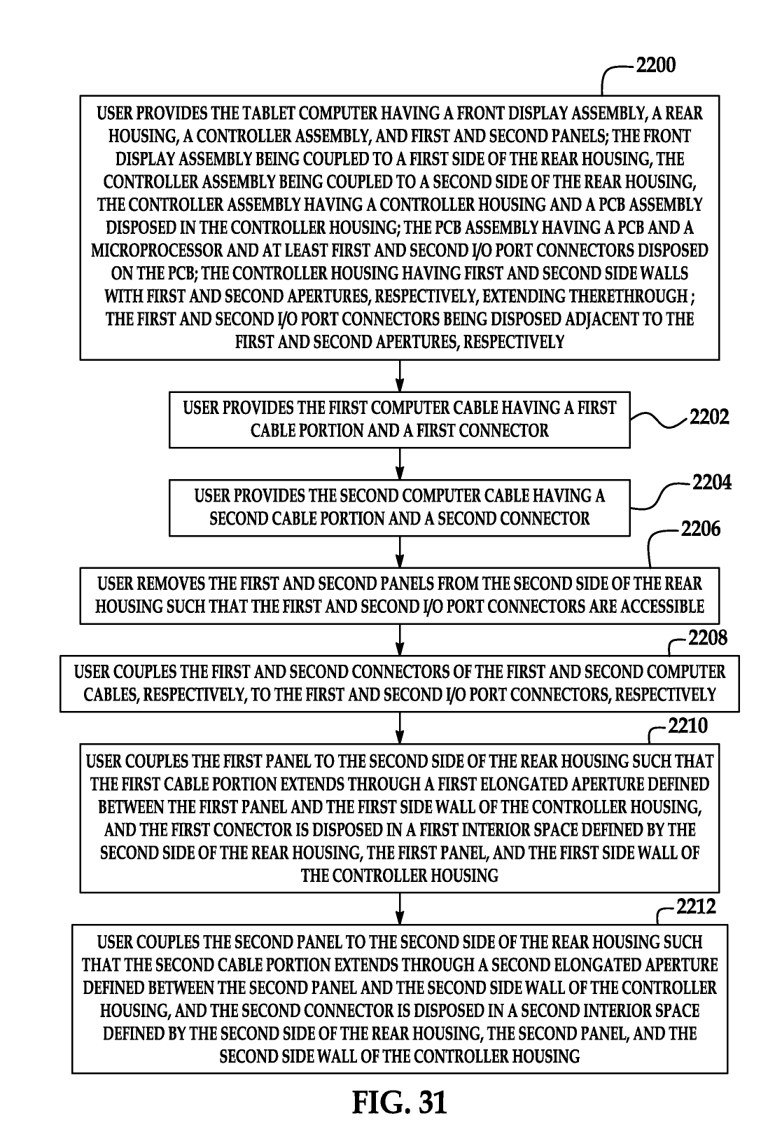

Referring to FIGS. 10, 23 and 31, a flowchart of a method for coupling computer cables to the tablet computer 10 in accordance with another exemplary embodiment will now be described.

At step 2200, a user provides the tablet computer 10 having a front display assembly 20, the rear housing 30, the controller assembly 40, and first and second panels 50, 52. The front display assembly 20 is coupled to the first side 500 of the rear housing 30. The controller assembly 40 is coupled to the second side 502 of the rear housing 30. The controller assembly 40 has the controller housing 1004 and the PCB assembly 1000 disposed in the controller housing 104. The PCB assembly 1000 has the PCB 1020 and the microprocessor 1024 and at least I/O port connectors 1028, 1052 disposed on the PCB 1020. The controller housing 1004 has side walls 1478, 1480 (shown in FIG. 20) with apertures 1628, 1652, respectively, extending therethrough. The I/O port connectors 1028, 1052 are disposed adjacent to the apertures 1628, 1652, respectively.

At step 2202, the user provides the computer cable 54 having the cable portion 2010 and the connector 2102.

At step 2204, the user provides the computer cable 57 having the cable portion 2140 and the connector 2142.

At step 2206, the user removes the first and second panels 50, 52 from the second side 428 of the rear housing 30 such that the I/O port connectors 1028, 1052 are accessible.

At step 2208, the user couples the connectors 2102, 2142 of the computer cables 54, 57, respectively, to the I/O port connectors 1028, 1052, respectively.

At step 2210, the user couples the first panel 50 to the second side 502 of the rear housing 30 such that the cable portion 2010 extends through a first elongated aperture 1910 defined between the first panel 50 and the side wall 1478 of the controller housing 1004, and the connector 2102 is disposed in a first interior space defined by the second side of the rear housing 502, the first panel 50, and the side wall 1478 of the controller housing 1004.

At step 2212, the user couples the second panel 52 to the second side 502 of the rear housing 30 such that the cable portion 2140 extends through a second elongated aperture 2010 defined between the second panel 52 and the side wall 1480 of the controller housing 1004, and the connector 2142 is disposed in a second interior space defined by the second side 502 of the rear housing 30, the second panel 52, and the side wall 1480 of the controller housing 1004.

The tablet computer described herein provides a substantial advantage over other computers. In particular, tablet computer utilizes the first and second panels which can be removed from a rear housing allow a user to at least couple first and second computer cables to first and second I/O port connectors, respectively, that are disposed proximate to and underneath the first and second panels, respectively. Thereafter, when the first and second panels are re-attached to the rear housing, the first and second panels define first and second elongated apertures between the panels and a controller housing which allow the first and second computer cables to extend therethrough while preventing access to the first and second I/O port connectors.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A tablet computer, comprising:
a front display assembly;
a rear housing defining an interior region that receives the front display assembly therein, the front display assembly being coupled to a first side of the rear housing;
a controller assembly being coupled to a second side of the rear housing, the controller assembly having a PCB assembly and a controller housing, the PCB assembly being disposed in the controller housing;
the PCB assembly having a microprocessor, a PCB, and at least a first I/O port connector; the microprocessor and the first I/O port connector being disposed on the PCB, the first I/O port connector being further operably coupled to the microprocessor;
the controller housing having a first side wall extending outwardly from the second side, the first side wall having a first aperture extending therethrough; the first I/O port connector being disposed adjacent to the first aperture such that the first I/O port connector communicates with the first aperture; and
a first panel being removably coupled to the second side of the rear housing and adjacent to the first side wall of the controller housing such that the first panel and the first side wall define a first elongated aperture therebetween that is disposed proximate to the first I/O port connector.

2. The tablet computer of claim 1, further comprising a first computer cable having a first connector and a first cable portion coupled to the first connector, the first cable portion extending through the first elongated aperture, and the first connector extending at least partially through the first aperture in the controller housing and being removably coupled to the first I/O port connector; and the second side of the rear housing, the first panel, and the first side wall of the controller housing defining a first interior space that entirely holds the first connector of the first computer cable therein.

3. The tablet computer of claim 1, wherein:
the PCB assembly further having a second I/O port connector being disposed on the PCB, the second I/O port connector being further operably coupled to the microprocessor;
the controller housing further having a second side wall extending outwardly from the second side, the second side wall having a second aperture extending therethrough;
the second I/O port connector being disposed adjacent to the second aperture such that the second I/O port connector communicates with the second aperture; and
the tablet computer further having a second panel being removably coupled to the second side of the rear housing and adjacent to the second side wall of the controller housing such that the second panel and the second side wall define a second elongated aperture therebetween that is disposed proximate to the second I/O port connector.

4. The tablet computer of claim 3, further comprising a second computer cable having a second connector and a second cable portion coupled to the second connector, the second cable portion extending through the second elongated aperture, and the second connector extending at least partially through the second aperture in the controller housing and being removably coupled to the second I/O port connector; and the second side of the rear housing, the second panel, and the first side wall of the controller housing defining a second interior space that entirely holds the second connector of the second computer cable therein.

5. The tablet computer of claim 3, wherein:
the PCB has at least first and second edges disposed apart from one another and extending substantially parallel to one another, the first and second I/O port connectors being coupled to the PCB proximate to the first and second edges, respectively;
the first and second side walls of the controller housing being disposed apart from one another and extending substantially parallel to one another, the first and second side walls having at least the first and second apertures, respectively, extending therethrough.

6. The tablet computer of claim 3, wherein the controller housing having a housing portion and a cover plate, the cover plate being coupled to the housing portion such that the cover plate and the housing portion define an interior space that the PCB assembly is disposed within.

7. The tablet computer of claim 6, wherein the housing portion has the first and second side walls and further having a third side wall, a fourth side wall, and a rear wall;
the first, second, third, and fourth side walls being coupled to and extending substantially perpendicular to the rear wall; the third and fourth side walls being disposed apart from one another and extending substantially parallel to one another.

8. The tablet computer of claim 7, wherein:
the housing portion of the controller housing further having first, second, third and fourth extension portions; the first and second extension portions being coupled to and extending outwardly from the first side wall; the third and fourth extension portions being coupled to and extending outwardly from the second side wall; the first, second, third and fourth extension portions having first, second, third, and fourth apertures, respectively, extending therethrough;
the second side of the rear housing further having first, second, third, and fourth studs being coupled to and extending outwardly from the substantially flat surface; the first, second, third, and fourth studs having first, second, third, and fourth stud apertures, respectively, extending therein; and
first, second, third, and fourth bolts being received through the first, second, third, and fourth apertures, respectively, of the first, second, third, and fourth extension portions, respectively, and being further received in the first, second, third, and fourth stud apertures, respectively, of the first, second, third, and fourth studs, respectively, to couple the controller housing to the rear housing.

9. The tablet computer of claim 1, wherein:
the rear housing having first, second, third, and fourth outer ends; the first and second outer ends of the rear housing being substantially parallel to one another, the third and fourth outer ends of the rear housing being substantially parallel to one another and perpendicular to the first and second outer ends, respectively, thereof; and
the second side of the rear housing defining a substantially flat surface, first and second riser surfaces, and first and second peripheral surfaces;
the substantially flat surface extending along a longitudinal axis and having first, second, third, and fourth ends; the first and second ends of the substantially flat surface being substantially parallel to one another, the third and fourth ends of the substantially flat surface being substantially parallel to one another and further being substantially perpendicular to the first and second ends thereof;
the first and second riser surfaces extending from the first and second ends, respectively, of the substantially flat surface in a direction substantially perpendicular to the substantially flat surface;
the first and second peripheral surfaces being disposed away from the substantially flat surface and extending from first and second riser surfaces, respectively, to the first and second outer ends, respectively, of the rear housing; the first and second peripheral surfaces further extending longitudinally and substantially parallel to one another.

10. The tablet computer of claim 9, wherein:
the first peripheral surface and the first riser surface having a first groove extending therein that defines a first panel receiving surface, the first panel receiving surface being disposed proximate to the third outer end of the rear housing; and
the second peripheral surface and the second riser surface having a second groove extending therein that defines a second panel receiving surface, the second panel receiving surface being disposed proximate to the third outer end of the rear housing, the first panel being disposed on the first and second panel receiving surfaces.

11. The tablet computer of claim 10, wherein the second side of the rear housing further includes first and second studs being disposed on the substantially flat surface between the first and second panel receiving surfaces, respectively; the first and second studs being further disposed proximate to the first and second panel receiving surfaces, respectively; the first and second studs having first and second stud apertures, respectively, extending therein.

12. The tablet computer of claim 11, wherein the first panel having first and second apertures extending therethrough, the first panel being coupled to the rear housing utilizing first and second bolts that are received through the first and second apertures, respectively, of the first panel and further received in the first and second stud apertures, respectively, of the first and second studs, respectively.

13. The tablet computer of claim 12, wherein the first panel has a first panel portion and first and second guiding members; the first and second guiding members being coupled to and extending from the first panel portion; the first and second guiding members being disposed adjacent to and contacting the first and second riser surfaces, respectively, when the first panel portion is disposed on the first and second panel receiving surfaces.

14. The tablet computer of claim 13, wherein the first panel further includes a second panel portion and at least first and second coupling members extending from the second panel portion, the second panel portion being coupled to and extending from an end of the first panel portion, the first and second coupling members being received within first and second side apertures, respectively, extending through the rear housing to further couple the first panel to the rear housing.

15. The tablet computer of claim 1, wherein the first panel has a groove extending into an end of the first panel that at least partially defines the first elongated aperture.

16. The tablet computer of claim 1, wherein:
the PCB assembly further having an electrical connector coupled to the PCB and operably coupled to the microprocessor;
the rear housing having an aperture extending therethrough; the controller housing having a second aperture extending therethrough; and
the controller housing being disposed proximate to the second side of the rear housing such that the second aperture is disposed adjacent to the aperture of the rear housing, and the electrical connector extending through the second aperture and the aperture of the rear housing and being electrically coupled to the front display assembly.

17. A method for coupling a computer cable to a tablet computer, comprising:
providing the tablet computer having a front display assembly, a rear housing, a controller assembly, and a first panel; the front display assembly being coupled to a first side of the rear housing, the controller assembly being coupled to a second side of the rear housing, the controller assembly having a controller housing and a PCB assembly disposed in the controller housing; the PCB assembly having a PCB and a microprocessor and at least a first I/O port connector disposed on the PCB; the controller housing having a first side wall with a first aperture extending therethrough; the first I/O port connector being disposed adjacent to the first aperture;
providing a first computer cable having a first cable portion and a first connector;
removing the first panel from the second side of the rear housing such that the first I/O port connector is accessible;
coupling the first connector of the first computer cable to the first I/O port connector; and
coupling the first panel to the second side of the rear housing such that the first cable portion extends through a first elongated aperture defined between the first panel and the first side wall of the controller housing, and first connector being entirely disposed in a first interior space defined by the second side of the rear housing, the first panel, and the first side wall of the controller housing.

18. The method of claim 17, wherein the tablet computer further includes a second panel; the PCB assembly further includes a second I/O port connector disposed on the PCB; the controller housing further includes a second side wall with a second aperture extending therethrough; the second I/O port connector being disposed adjacent to the second aperture; the method further comprising:
providing a second computer cable having a second cable portion and a second connector;
removing the second panel from the second side of the rear housing such that the second I/O port connector is accessible;
coupling the second connector of the second computer cable to the second I/O port connector; and
coupling the second panel to the second side of the rear housing such that the second cable portion extends through a second elongated aperture defined between the second panel and the second side wall of the controller housing, and second connector being entirely disposed in a second interior space defined by the second side of the rear housing, the second panel, and the second side wall of the controller housing.
